(19) United States
(12) Patent Application Publication
(10) Pub. No.: US 2011/0043675 A1
(43) Pub. Date: Feb. 24, 2011

(54) SOLID-STATE IMAGE SENSING DEVICE AND METHOD OF DRIVING THE SAME

(76) Inventor: Takahiro MATSUDA, Kawasaki-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/859,826

(22) Filed: Aug. 20, 2010

(30) Foreign Application Priority Data
Aug. 20, 2009 (JP) 2009-191264

(51) Int. Cl. H04N 5/335

(52) U.S. Cl. 348/300; 348/308; 348/E05.091

(57) ABSTRACT

According to the embodiments, a method of driving a solid-state image sensing device includes, selecting a read target row of a pixel region and resetting a voltage of a detector to a reference level of a video signal, and enabling a source follower circuit of the unit pixel as a preliminary operation for an operation of raising the voltage of the detector set at the reference level of the video signal of the unit pixel. And the start of resetting to the reference level is earlier than or simultaneous with a start of enabling the source follower circuit.

### CROSS-REFERENCE TO RELATED APPLICATIONS

This application is based upon and claims the benefit of priority from Japanese Patent Application No. 2009-191264, filed Aug. 20, 2009; the entire contents of which are incorporated herein by reference.

### FIELD

Embodiments described herein relate generally to a solid-state image sensing device and a method of driving the same, and are applied to, e.g., a CMOS image sensor.

### BACKGROUND

In pixel regions of some solid-state image sensing devices, a row from which a pixel signal is to be read out is selected by pulse-driving the drain of a reset transistor of a detector and the drain of a pixel signal amplification transistor.

### BRIEF DESCRIPTION OF THE DRAWINGS

FIG. 1 is a block diagram showing an example of the overall configuration of a solid-state image sensing device according to the first embodiment;

FIG. 2 is an equivalent circuit diagram for explaining a configuration example of a pixel region of the solid-state image sensing device according to the first embodiment;

FIG. 3 is a timing chart showing the driving operation of the solid-state image sensing device according to the first embodiment;

FIG. 4 is a graph for explaining the output variations of the solid-state image sensing device according to the first embodiment and a solid-state image sensing device according to a comparative example;

FIG. 5 is an equivalent circuit diagram for explaining a configuration example of a pixel region of a solid-state image sensing device according to the second embodiment;

FIG. 6 is a timing chart showing the driving operation of the solid-state image sensing device according to the second embodiment;

FIG. 7 is an equivalent circuit diagram for explaining a configuration example of a pixel region of a solid-state image sensing device according to the third embodiment;

FIG. 8 is a timing chart showing the driving operation of the solid-state image sensing device according to the third embodiment; and

FIG. 9 is a timing chart showing the driving operation of a solid-state image sensing device according to a comparative example.

### DETAILED DESCRIPTION

In general, according to one embodiment, a method of driving a solid-state image sensing device according to an aspect of an embodiment comprises selecting a read target row of a pixel region and resetting a voltage of a detector to a reference level of a video signal, and enabling a source follower circuit of the unit pixel as a preliminary operation for an operation of raising the voltage of the detector set at the reference level of the video signal of the unit pixel, wherein a start of resetting to the reference level is earlier than or simultaneous with a start of enabling the source follower circuit.

To widen the dynamic range of the detector (DN), it is presumably effective to raise the dropped reference voltage of the detector (DN) again by inducing the voltage fluctuation of a vertical signal line (DL) to the detector (DN) by the ON/OFF operation of a cutoff transistor (TI) of the source follower in the pixel region.

Unfortunately, the fluctuation of the vertical signal line (DL) is transferred to a photodiode (PD), and this often deteriorates the image quality.

In each of the following embodiments, therefore, a solid-state image sensor capable of improving the image quality and a method of driving the same will be explained.

The embodiments will be explained below with reference to the accompanying drawing. Each embodiment will be explained by taking a CMOS image sensing device as an example of the solid-state image sensing device. Note that in the following explanation, the same reference numerals denote the same parts throughout the drawing.

### First Embodiment

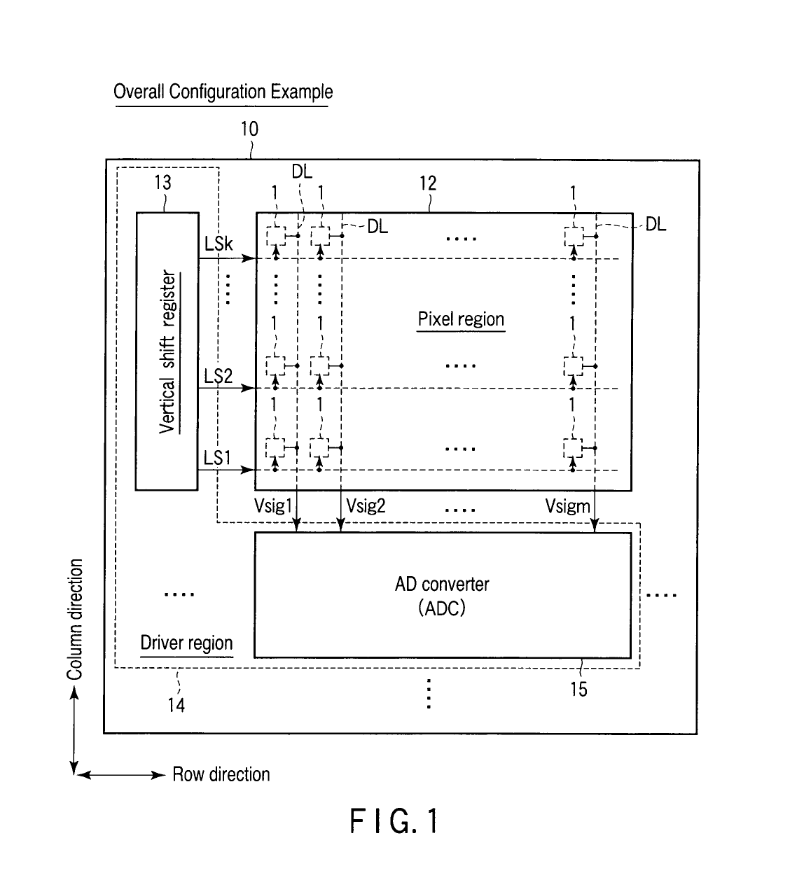

First, a solid-state image sensing device and a method of driving the same according to the first embodiment of the present invention will be explained below with reference to FIGS. 1, 2, 3, and 4.

### 1. Configuration Example

### 1-1. Overall Configuration Example

An example of the overall configuration of a solid-state image sensing device according to the first embodiment will be explained below with reference to FIG. 1. This embodiment is an example in which an AD converter is placed in the column position of a pixel region.

As shown in FIG. 1, a solid-state image sensing device 10 according to this embodiment includes a pixel region 12 and driver region 14.

The pixel region 12 includes unit pixels 1 arranged in a matrix on a semiconductor substrate and each including a photoelectric converter and signal scanning circuit.

The photoelectric converter includes, e.g., a photodiode for photoelectric conversion and storage, and functions as an image sensor. The signal scanning circuit includes an amplification transistor (to be described later) and the like. The signal scanning circuit reads out a signal from the photoelectric converter, amplifies the readout signal, and transmits the amplified signal to an AD converter 15.

The driver region 14 includes a vertical shift register 13 for driving the above-mentioned signal scanning circuits, and drivers such as the AD converter.

The vertical shift register 13 functions as a selector and controller for outputting signals LS1 to LSk to the pixel region 12, selecting the unit pixels 1 row by row, and applying a predetermined voltage signal (e.g., RESETn) to a read target row. The unit pixels 1 of the selected row each output an analog signal Vsig corresponding to the amount of incident light through a vertical signal line DL.

The AD converter (ADC) 15 converts the analog signal Vsig input through the vertical signal line DL into a digital signal.

Note that the overall configuration is not limited to this example. That is, it is also possible to use, e.g., an arrangement in which the ADC is placed not in the column position but on the chip level, or an arrangement in which no ADC is placed on the sensor chip.

### 1-2. Configuration Example of Pixel Region

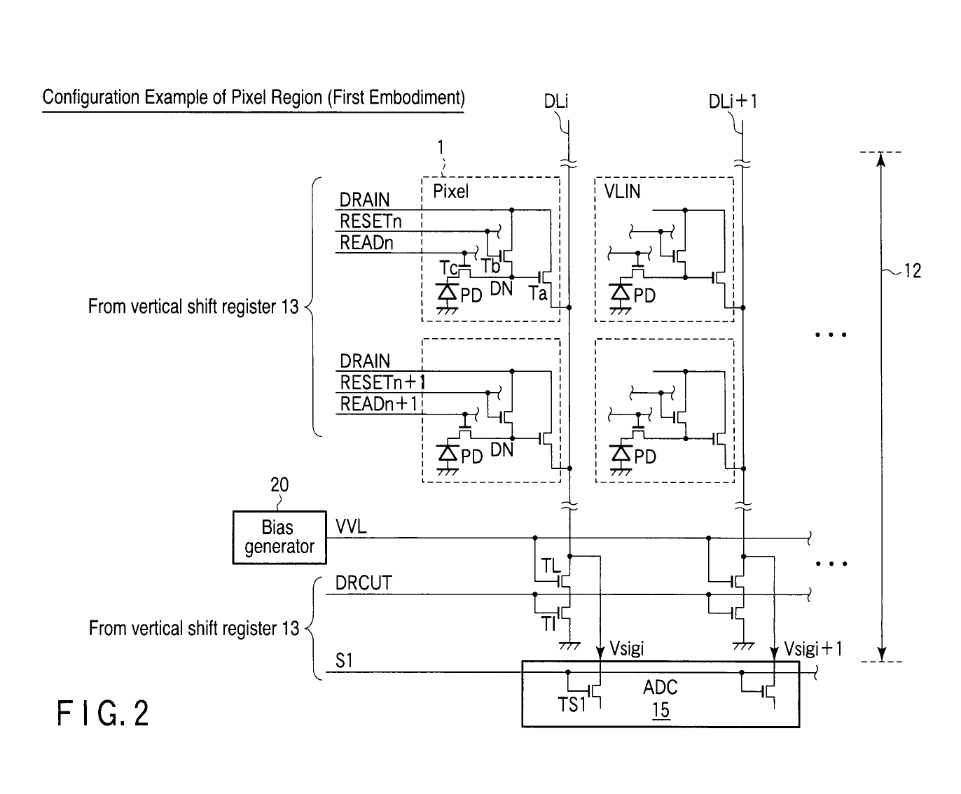

A configuration example of the pixel region of the solid-state image sensing device according to the first embodiment will be explained below with reference to FIG. 2. The arrangement shown in FIG. 2 includes the pixel region 12 and the driver region 14 for explaining the pixel region.

The pixel region 12 includes a plurality of unit pixels 1 arranged in a matrix at the intersections of row lines (e.g., signal lines RESETn) and vertical signal lines DL, transistors TL and TI, and a bias generator 20.

Each unit pixel 1 includes a detection node DN functioning as a detector, three transistors (an amplification transistor Ta, reset transistor Tb, and read transistor Tc), and a photodiode (PD).

The amplification transistor Ta includes a source connected to the vertical signal line DL, a drain connected to a signal line DRAIN, and a gate connected to the node DN as a detector of the unit pixel.

The reset transistor Tb includes a source connected to the node DN as a detector, a drain connected to the signal line DRAIN, and a gate connected to the signal line RESETn.

The read transistor Tc includes a source connected to the cathode of the photodiode PD, a drain connected to the node DN as a detector, and a gate connected to a signal line READn.

The anode of the photodiode PD is connected to a ground power supply voltage (GND).

The transistors TL and TI and bias generator 20 are arranged in a peripheral region shown in the lower portion of the pixel region 12 in FIG. 2.

The transistor TL is a load transistor of a source follower circuit. The transistor TL includes a source connected to the drain of the transistor TI, a drain connected to the vertical signal line DL and the input of the AD converter 15, and a gate connected to an output voltage VVL of the bias generator 20.

The transistor TI is a cutoff transistor of the source follower circuit. The transistor TI includes a source connected to the ground power supply voltage (GND), and a gate connected to a signal line DRCUT.

The vertical signal line DL as the output of the source follower circuit formed by the amplification transistor Ta and load transistor TL is connected to the AD converter 15.

The AD converter 15 includes transistors TS1 as sample-and-hold transistors of the outputs of the source follower circuits in the pixel region 12. The transistors TS1 include drains that receive analog signals (Vsigi, Vsigi+1, . . . ) as output signals of the vertical signal lines (DLi, DLi+1, . . . ), and gates connected to a signal line S1.

### <2. Driving Operation>

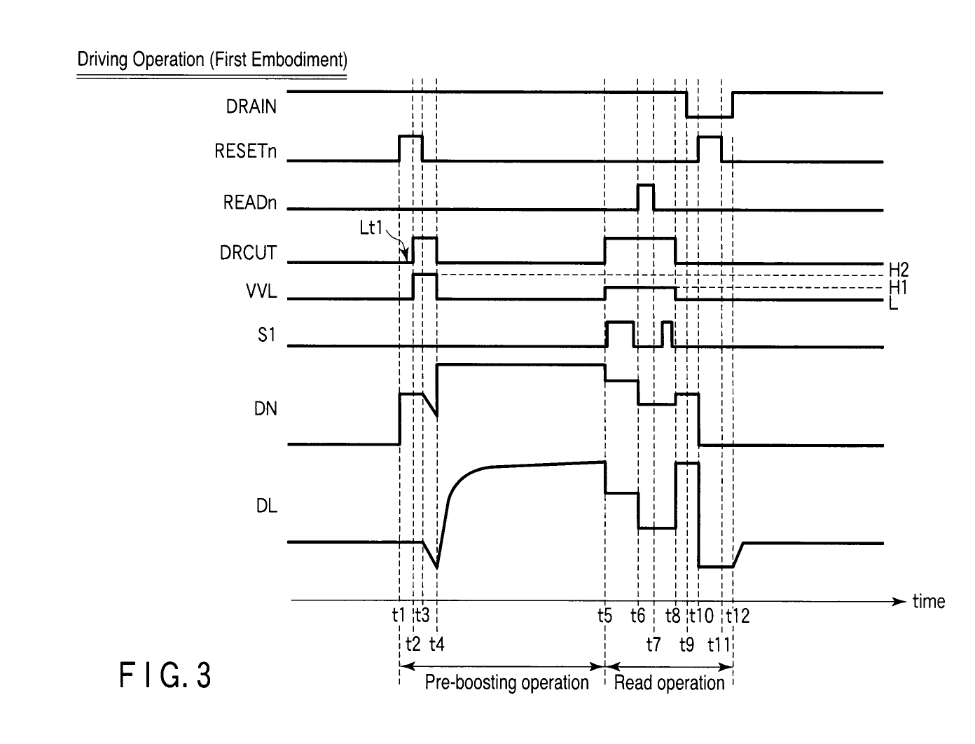

The driving operation of the solid-state image sensing device according to the first embodiment will be explained below with reference to FIG. 3. This explanation will be made in accordance with a timing chart shown in FIG. 3. Note that the difference from a comparative example (to be described later) is that before the signal line DRCUT is set at “H” level, the reset transistor Tb is turned on by setting the signal line RESETn at “H” level, thereby fixing the detection node DN at “H” level, under the control of the vertical shift register 13. At time t1, therefore, the voltage level of the signal DRCUT is “L” level (Lt1).

The vertical shift register 13 performs control to obtain the voltage relationship as described above.

Accordingly, when turning on the cutoff transistor TI as a pre-boosting operation of the detection node DN, it is possible to suppress the voltage drop of the detection node DN induced by the voltage drop of the vertical signal line DL, unlike in the comparative example (to be described later).

Consequently, this embodiment can prevent the fluctuation of the vertical signal line DL from being transferred as the voltage drop of the detection node DN to the photodiode PD, thereby preventing the mixing of noise in the unit pixel 1. This makes it possible to improve the image quality.

### (First Step)

First, at first time t1, the reset transistor Tb is turned on by setting the signal line RESETn at “H” level, thereby setting the detection node DN at a reference voltage (reset level). This step is performed in order to remove an invalid signal such as a dark current stored in the detection node DN, before reading out a signal charge photoelectrically converted by the photodiode PD for a predetermined period.

Note that at time t1, the application signal DRAIN at the drain terminals of the amplification transistor Ta and reset transistor Tb is set at “H” level. When the reference voltage (reset level) of the detection node DN is set at “H” level, therefore, the detection node DN functions as a charge detector and select an unselected row. Note also that the detection nodes DN of other rows are set at “L” level and do not function as charge detectors, so these rows are unselected.

### (Second Step)

Then, at time t2, the cutoff transistor TI is turned on by setting the signal line DRCUT at “H” level, and the bias voltage VVL of the load transistor TL is raised to a voltage (H2 level). Since this forms a path to the GND via the load transistor TL and cutoff transistor TI, the voltage of the vertical signal line DL drops. This step is a preliminary operation for the operation of boosting the detection node DN at time t4. In addition, the amount of voltage drop of the vertical signal line DL increases because the bias voltage VVL of the load transistor TL is raised.

Note that at time t2, the reset transistor Tb is kept ON to fix the detection node DN at “H” level, so the voltage drop of the vertical signal line DL is not transferred to the pixel PD via the detection node DN. This prevents the mixing of noise in a video signal of the unit pixel 1 caused by the pre-boosting operation of the detection node DN.

### (Third Step)

Subsequently, at time t3, while the signal line DRCUT is kept at “H” level and the cutoff transistor TI connected to the load transistor TL is kept ON, the reset transistor Tb is turned off by setting the signal line RESETn at “L” level.

### (Fourth Step)

At time t4, the cutoff transistor TI is turned off by setting the signal line DRCUT at “L” level, and the bias voltage VVL of the load transistor TL is returned to the original voltage (H1).

The voltage relationship at times t3 and t4 cuts the path from the source follower circuit (Ta to TL) of the unit pixel 1 to the ground power supply voltage GND. In addition, since the signal line DRAIN is at “H” level, the gate of the amplification transistor Ta is at “H” level, so the voltage of the vertical signal line DL rises.

In this state, the detection node DN floats because both the reset transistor Tb and read transistor Tc are OFF, and has a coupling capacitance with the vertical signal line DL owing to the amplification transistor Ta. Consequently, the voltage of the detection node DN rises with the voltage rise of the vertical signal line DL (boosting of the detector).

Note that during the period (t2 to t4) in which DRCUT is kept at “H” level in order to boost the detection node DN, the boosting effect is increased by raising the bias voltage VVL of the load transistor TL.

### (Fifth Step)

At time t5, to read out the signal charge photoelectrically converted by the photodiode PD, the cutoff transistor TI is turned on by setting the signal lines DRCUT and S1 at “H” level, thereby operating the source follower circuit (Ta to TL) of the unit pixel 1. Since this operation forms a path from the vertical signal line DL to the ground power supply voltage GND through the load transistor TL and cutoff transistor TI, the voltage of the vertical signal line DL drops. Also, the voltage of the detection node DN drops with the voltage drop of the vertical signal line DL owing to the coupling capacitance with the amplification transistor Ta (the drop of the detector reset level).

Note that the boosting operation of the detection node DN performed at time t4 described previously cancels the reset level drop of the detection node DN at time t5, and raises the level more than the amount of drop. This is so because the voltage drop of the detection node DN further increases if the boosting operation of the detection node DN as described above is not performed.

### (Sixth Step)

At time t6, the read transistor Tc is turned on by setting the signal line READn at “H” level, thereby reading out the electric charge stored in the photodiode PD to the detection node DN. In this state, the voltage of the detection node DN drops from the reset level in accordance with the readout charge amount. This voltage drop is transferred to the vertical signal line DL by the amplification transistor Ta, and drops the voltage of the vertical signal line DL.

In addition, the pixel signal sample-and-hold transistor TS1 in the AD converter 15 is turned off by setting the signal line S1 at “L” level, after sampling the reset level of the unit pixel 1.

### (Seventh Step)

At time t7, the read transistor Tc is turned off by setting the signal line READn at “L” level.

Subsequently, the transistor TS1 is turned on by setting the signal line S1 at “H” level, thereby sampling the signal level of the unit pixel 1 in the AD converter 15. After that, at time t8, the transistor TS1 is turned off by setting the signal line S1 at “L” level. Accordingly, the AD converter 15 performs AD conversion on the difference between the reset level and signal level sampled by the transistor TS1, and outputs a digital signal outside. Thus, the pixel signal of the unit pixel 1 is read out.

As described above, the pixel signal that undergoes the AD conversion is the difference between the reset level and the pixel signal having further decreased from the reset level. Therefore, if the reset level itself of the detection node DN decreases, a maximum signal amount detectable as a pixel signal reduces (the reduction in dynamic range).

In this embodiment, however, the boosting operation of the detection node DN performed based on the above-mentioned voltage relationship at time t4 can raise the voltage level of the detection node DN by the amount larger than the amount of drop in reset level.

This advantageously makes it possible to widen the dynamic range of the detection node DN.

### (Eighth Step)

At time t8, the cutoff transistor TI is turned off by setting the signal lines DRCUT and VVL at “L” level, thereby cutting the path between the ground power supply voltage GND of the source follower circuit (Ta to TL) of the unit pixel 1 and the AD converter 15.

### (Ninth Step)

At time t9, the drain terminals of the amplification transistor Ta and reset transistor Tb are set at “L” level by setting the signal line DRAIN at “L” level.

### (10th Step)

At time t10, the reset transistor Tb is turned on by setting the signal line RESETn at “H” level, thereby setting the detection node DN at “L” level again. This disables the amplification transistor Ta, and makes the selected row unselected.

### (11th Step)

At time t11, the reset transistor Tb is turned off by setting the signal line RESETn at “L” level.

### (12th Step)

Finally, at time t12, the drain terminals of the amplification transistor Ta and reset transistor Tb are returned to “H” level by setting the signal line DRAIN at “H” level, thereby preparing for a read operation of the next line.

### <3. Effects>

The solid-state image sensing device and the method of driving the same according to the first embodiment achieve at least effects (1) and (2) below.

(1) The image quality can be improved.

As described above, the solid-state image sensing device according to this embodiment includes the pixel region 12 including the plurality of unit pixels 1 each including the detector DN, and arranged at the intersections of the row lines (e.g., RESETn) and the vertical signal lines DL, and the vertical shift register 13 that performs at least the first step of selecting a read target row of the pixel region and resetting the voltage of the detector DN to the reference level of a video signal, and the second step of enabling the source follower circuit (Ta to TL) of the unit pixel 1, as a preliminary operation for the operation of raising the voltage of the detector DN set at the reference level of the video signal of the unit pixel 1, and controls the pixel region 12 such that the start (time t1) of the first step is earlier than or simultaneous with the start (time t2) of the second step.

The method of driving the solid-state image sensing device according to this embodiment includes the first step of selecting a read target row of the pixel region 12 and resetting the voltage of the detector DN to the reference level of a video signal, and the second step of enabling the source follower circuit (Ta to TL) of the unit pixel 1, as a preliminary operation for the operation of raising the voltage of the detector DN set at the reference level of the video signal of the unit pixel 1, wherein the start (time t1) of the first step is earlier than or simultaneous with the start (time t2) of the second step.

In the arrangement and the method of driving the same described above, the vertical shift register 13 performs control to obtain the voltage relationship as described above. When turning on the cutoff transistor TI as the pre-boosting operation of the detection node DN, therefore, it is possible to suppress the voltage drop of the detection node derived by the voltage drop of the vertical signal line DL, unlike in the comparative example (to be described later).

Consequently, this embodiment can prevent the voltage drop of the vertical signal line DL from being transferred to the photodiode PD as the voltage drop of the detection node DN, thereby preventing the mixing of noise in the unit pixel 1. This makes it possible to improve the image quality.

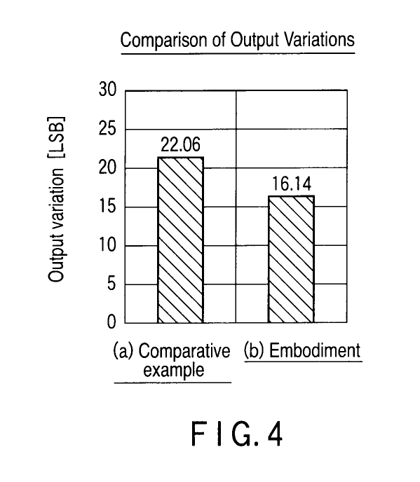

For example, as shown in FIG. 4, the improvement of the image quality is obvious when comparing the output variation [LSB] of the comparative example to be described later ((a) in FIG. 4) with that of the first embodiment ((b) in FIG. 4).

The output variation [LSB] is a statistical numerical value (standard deviation σ) indicating the nonuniformity of the pixel output. That is, in a state in which signals output from two-dimensionally arranged pixels are uniform (e.g., in a dark state (in which no light strikes the pixels)), all the pixel outputs are supposed to be uniform. However, the pixel outputs become nonuniform owing to factors such as pixel defects, the fabrication variations of transistors forming the pixels, and noise when circuits are in operation.

More specifically, the output variation [σ] of digitally converted values A1 to A(N×M) of N×M pixel signals two-dimensionally arranged in a matrix is indicated by

σ={(N×M)ΣA²−(ΣA)²/(N×m)(N×M−1)}^{1/2}

Note that 1 [LSB] is a minimum value (resolution) when the pixel signal is digitally converted.

As shown in FIG. 4, the output variation according to the comparative example indicated by (a) is about 22.06 [LSB]. On the other hand, the output variation according to the first embodiment indicated by (b) in FIG. 4 is about 16.14 [LSB], i.e., the image quality can be improved. This clearly shows that the arrangement and driving operation according to this embodiment are advantageous as they can improve the image quality by at least about 30% in respect of the output variation. As described above, it is possible to prevent the deterioration of the image quality as a side effect when performing the preliminary operation for widening the dynamic range of the pixel signal detector DN.

(2) The dynamic range of the detector DN of the unit pixel 1 can be widened.

As explained above at time t7, the difference between the reset level and the pixel signal having further decreased from the reset level undergoes AD conversion as a pixel signal. If the reset level itself of the detection node DN drops, therefore, a maximum signal amount detectable as a pixel signal reduces (the reduction in dynamic range).

In this embodiment, however, the voltage level of the detection node DN can be raised more than the drop amount of the reset level by the boosting operation performed on the detection node DN at time t4 based on the above-mentioned voltage relationship. This boosting effect can advantageously broaden the dynamic range of the detection node DN.

### Second Embodiment (Embodiment in which Cutoff Transistor TI is Omitted)

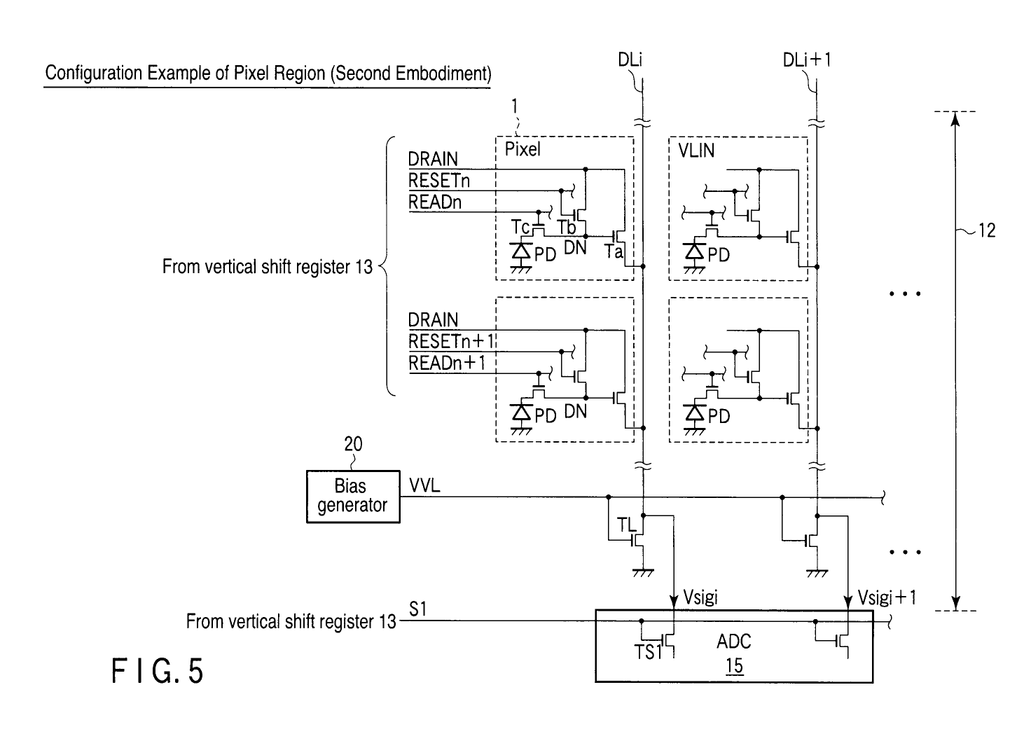

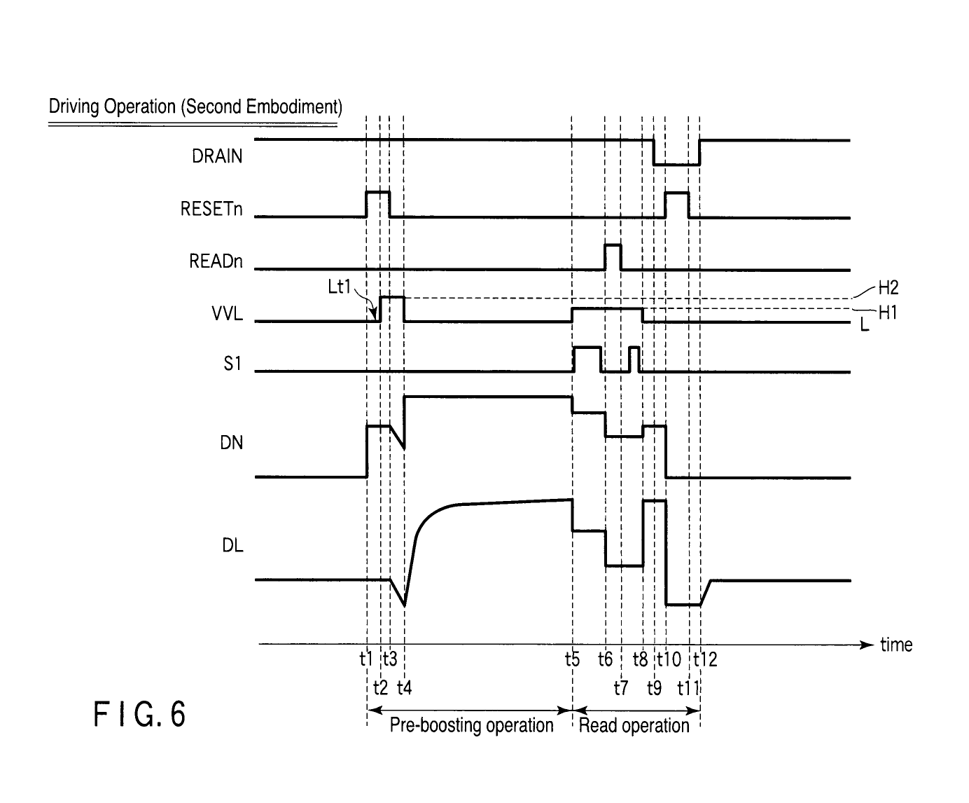

Next, a solid-state image sensing device and a method of driving the same according to the second embodiment will be explained below with reference to FIGS. 5 and 6. This embodiment is directed to an example in which the cutoff transistor TI is omitted. In the following description, a repetitive explanation of the first embodiment will be omitted.

### Configuration Example

First, a configuration example of the solid-state image sensing device according to this embodiment will be explained below with reference to FIG. 5. The solid-state image sensing device according to this embodiment differs from that according to the above-mentioned first embodiment in that the cutoff transistor TI is omitted, as shown in FIG. 5.

As will be described later, therefore, the operation of enabling/disabling a source follower circuit (Ta to TL) of a unit pixel 1 is performed using a load transistor TL electrically connected to the source terminal of an amplification transistor Ta of the unit pixel 1.

### <Driving Operation>

The driving operation of the solid-state image sensing device according to this embodiment will be explained below with reference to FIG. 6.

In the first embodiment, the ground power supply voltage GND path of the pixel source follower circuit is cut by a cutoff transistor TI by controlling the voltage level of a signal line VVL. As shown in FIG. 6, however, the second embodiment differs from the first embodiment in that the load transistor TL performs this cutting operation.

Accordingly, a bias generator 20 controls the signal line VVL to be applied to the gate of the load transistor TL by three values, i.e., “L” level as a period during which the ground power supply voltage GND path is cut, intermediate bias voltage level 1 (“Hl” level) as a pixel signal read period, and intermediate bias voltage level 2 (“H2” level (>“H1” level)) as a boosting operation period of a detector DN.

For example, at time t2, the voltage level of the signal line VVL is set at intermediate bias level 2 (“H2” level) under the control of the bias generator 20. Similarly, at time t4, the voltage level of the signal line VVL is set at bias level L (“L” level) under the control of the bias generator 20. Likewise, at time t5, the voltage level of the signal line VVL is set at intermediate bias level 1 (“H1” level) under the control of the bias generator 20.

To obtain a higher boosting effect, it is desirable to decrease the voltage of a vertical signal line DL by decreasing the ON resistance of the load transistor TL by making intermediate bias level 2 (“H2” level) close to “H” level, thereby increasing the voltage rise amount of the vertical signal line DL when the load transistor TL is turned off. If this operation is unnecessary, intermediate bias level 2 (“H2” level) may be the same voltage level as intermediate bias level 1 (“H1” level).

Note that a vertical shift register 13 may also perform the three-value voltage level control of the signal line VVL described above, instead of the bias generator 20.

### <Effects>

As described above, the solid-state image sensing device and the method of driving the same according to the second embodiment achieve at least the same effects as effects (1) and (2) described previously.

In addition, in this embodiment, the bias generator 20 controls the signal line VVL to be applied to the gate of the load transistor TL by using the three values, i.e., “L” level as the period during which the ground power supply voltage GND path is cut, intermediate bias voltage level 1 (“H1” level) as the pixel signal read period, and intermediate bias voltage level 2 (“H2” level) as the boosting operation period of the detector DN.

Accordingly, the cutoff transistor TI can be omitted, and the load transistor TL can perform the operation of enabling/disabling the source follower circuit (Ta to TL) of the unit pixel 1. Consequently, the arrangement and its driving operation according to this embodiment are advantageous in reducing the occupied area.

Also, this embodiment is advantageous in that the dynamic range of the source follower (Ta to TL) can be widened toward the GND by the threshold voltage of the cutoff transistor TI.

### Third Embodiment (Embodiment in which Unit Pixel Further Includes Selection Transistor Td)

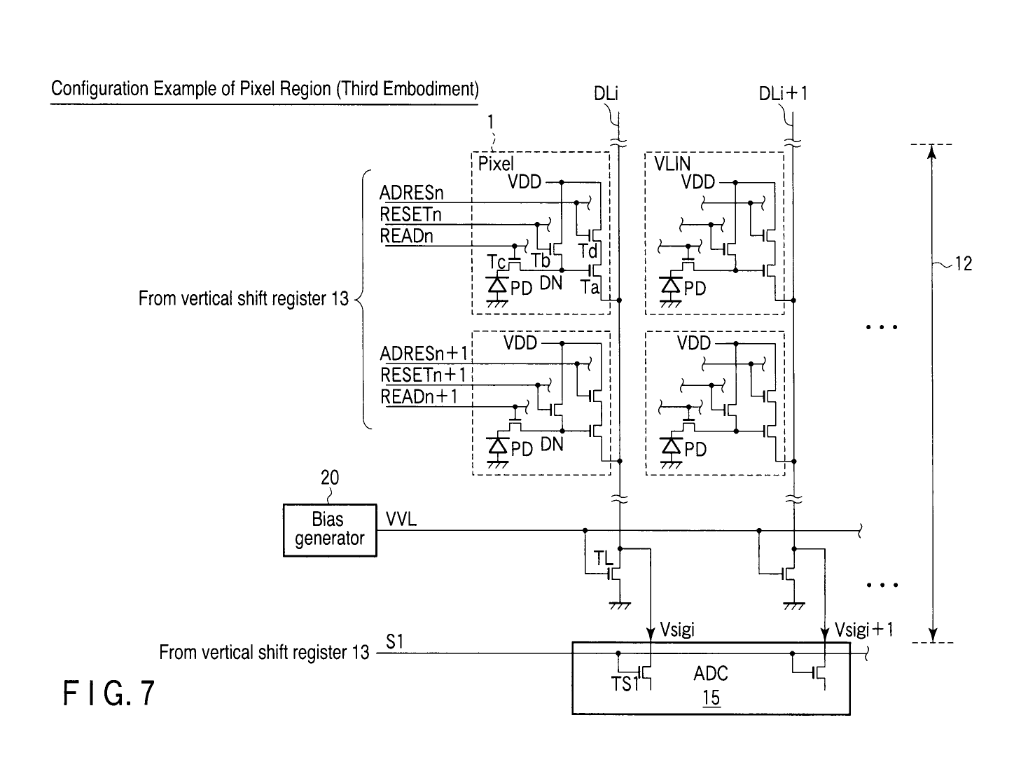

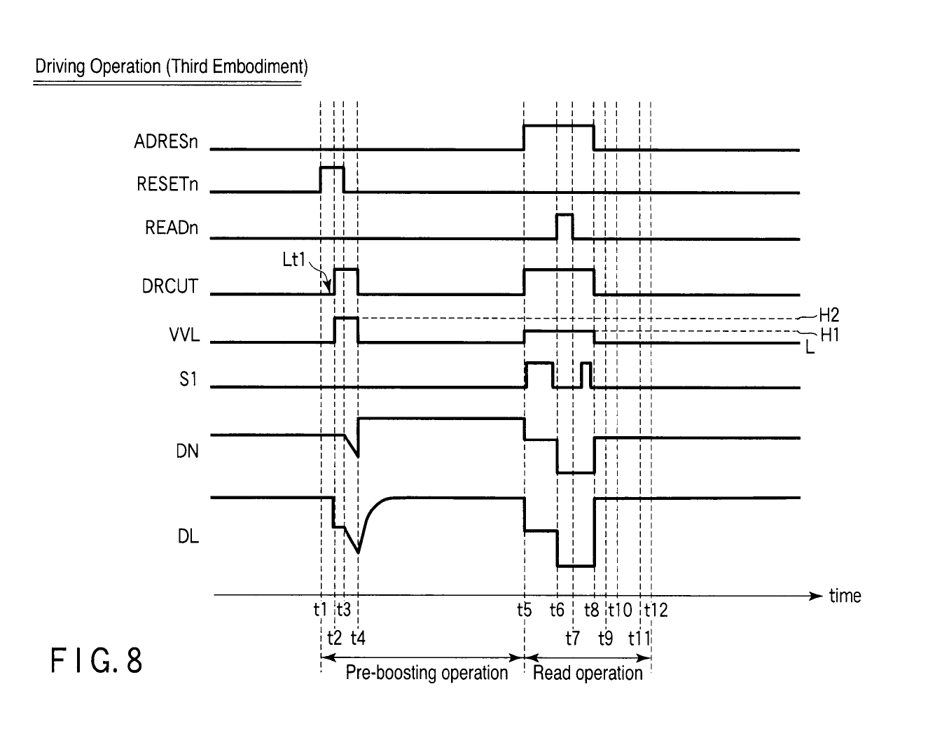

A solid-state image sensing device and a method of driving the same according to the third embodiment will be explained below with reference to FIGS. 7 and 8. This embodiment is directed to an example in which a unit pixel 1 further includes a selection transistor Td. In the following description, a repetitive explanation of the above-mentioned first embodiment will be omitted.

### Configuration Example

First, the solid-state image sensing device according to this embodiment will be explained below with reference to FIG. 7.

The solid-state image sensing device according to the third embodiment differs from the first embodiment in that the unit pixel further includes the selection transistor Td.

The selection transistor Td includes a source connected to the drain of an amplification transistor Ta, a drain connected to an internal power supply voltage VDD, and a gate connected to a signal line ADRESn. In other words, the drain of the amplification transistor Ta is connected to the source of the selection transistor Td, the signal ADRESn is applied to the gate of the selection transistor Td, and the drain of the selection transistor Td is connected to the internal power supply voltage VDD of a pixel region 12.

The drain of a reset transistor Tb is also connected to the internal power supply voltage VDD of the pixel region 12.

### <Driving Operation>

The driving operation of the solid-state image sensing device according to this embodiment will be explained below with reference to FIG. 8.

In the first embodiment described above, a read target row is selected/made unselected by pulse-driving the drain terminals of the amplification transistor Ta and reset transistor Tb by a signal DRAIN. As shown in FIG. 8, the third embodiment differs from the first embodiment in that this operation is performed by turning on/off the application signal ADRESn of the selection transistor Td.

For example, at time t5, a read target row is selected by setting the voltage level of the signal line ADRESn at “H” level and turning on the current path of the selection transistor Td under the control of the vertical shift register 13.

### <Effects>

As described above, the solid-state image sensing device and the method of driving the same according to this embodiment achieve at least the same effects as effects (1) and (2) described previously.

In addition, in this embodiment, the selection transistor Td selects a read target row. Since this makes it unnecessary to pulse-drive the drain terminal of the reset transistor Tb and makes it possible to apply a DC voltage to this drain terminal, the power supply voltage VDD of the pixel region 12 can directly be applied without using the drain driver circuit. Consequently, the voltage to be applied to the detection node DN when the reset transistor Tb is at “H” level can be increased by the ON resistance of the drain driver circuit. This makes the embodiment advantageous in that the dynamic range of the detection node DN of the unit pixel 1 can further be widened.

### Comparative Example

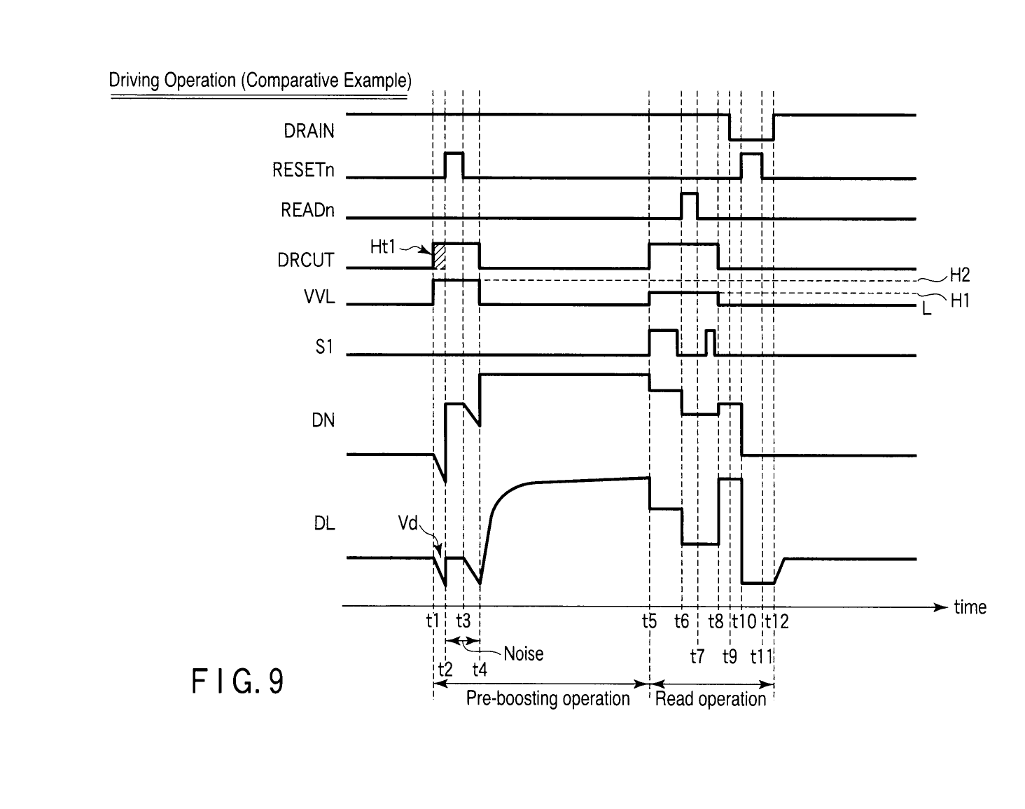

For comparison with the solid-state image sensing devices and the methods of driving the same according to the first to third embodiments described above, a solid-state image sensing device and a method of driving the same according to a comparative example will be explained below with reference to FIG. 9. This comparative example is directed to an example in which a pre-boosting operation can generate noise. In this description, a repetitive explanation of the above-mentioned embodiments will be omitted.

### <Driving Operation>

The driving operation of the solid-state image sensing device according to the comparative example will be explained with reference to FIG. 9.

As shown in FIG. 9, at time t1, as a pre-boosting operation of a detector (DN), a cutoff transistor (TI) is turned on by setting a signal line DRCUT at “H” level.

This operation forms a path from a vertical signal line (DL) to a ground power supply voltage (GND) through a load transistor (TL) and the cutoff transistor (TI). Accordingly, the voltage of the vertical signal line DL drops by a voltage Vd. This voltage drop (Vd) is induced by the coupling effect of an amplification transistor (Ta), and drops the voltage of the detector (DN). Although a read transistor (Tc) is turned off, it is only held at the pinning potential. Therefore, the voltage drop of the detector (DN) is transferred to a photodiode (PD) over the read transistor (Tc). This leak transferred to the photodiode (PD) deteriorates the image quality as noise.

As described above, the voltage level of the signal line DRCUT is at “H” level (Ht1).

Subsequently, at time t2, a reset transistor (Tb) is turned on by setting a signal line RESETn at “H” level, thereby setting the detector (DN) at a reference voltage (reset level) in order to remove an invalid signal such as a dark current stored in the detector (DN).

In the arrangement and its driving operation according to the comparative example as described above, the fluctuation of the vertical signal line (DL) is transferred to the photodiode (PD) and generates noise as indicated at time t1. This results in the disadvantage that the image quality degrades.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of driving a solid-state image sensing device, comprising:
selecting a read target row of a pixel region and resetting a voltage of a detector to a reference level of a video signal; and
enabling a source follower circuit of the unit pixel as a preliminary operation for an operation of raising the voltage of the detector set at the reference level of the video signal of the unit pixel,
wherein a start of resetting to the reference level is earlier than or simultaneous with a start of enabling the source follower circuit.

2. The method of claim 1, further comprising, after enabling the source follower circuit, raising a voltage of a vertical signal line in order to raise the reference level of the video signal.

3. The method of claim 2, further comprising enabling the source follower circuit of the unit pixel, and sampling-and-holding the reference level of a video signal output to the vertical signal line in an AD converter, in order to read out a pixel signal.

4. The method of claim 3, further comprising reading out electric charge obtained by photoelectric conversion to the detector, and sampling-and-holding a video signal output to the vertical signal line in the AD converter.

5. The method of claim 4, further comprising disabling the source follower circuit of the unit pixel.

6. The method of claim 5, further comprising making a selected read target row unselected.

7. The method of claim 5, further comprising enabling and disabling the source follower circuit by an operation of a load transistor of the source follower circuit.

8. The method of claim 2, wherein the read target row is selected/made unselected by using a selection transistor connected to a drain terminal of an amplification transistor of the unit pixel.

9. The method of claim 1, further comprising, controlling a gate of a load transistor by three values.

10. A solid-state image sensing device comprising:
a pixel region comprising a plurality of unit pixels each of which includes a detector, and which are arranged at intersections of row lines and vertical signal lines; and
a vertical shift register which performs at least an operation of selecting a read target row of the pixel region and resetting a voltage of the detector to a reference level of a video signal, and an operation of enabling a source follower circuit of the unit pixel as a preliminary operation for an operation of raising the voltage of the detector set at the reference level of the video signal of the unit pixel, and controls the pixel region such that a start of resetting to the reference level is earlier than or simultaneous with a start of enabling the source follower circuit.

11. The device of claim 10, further comprising a cutoff transistor which is a transistor of the source follower circuit.

12. The device of claim 10, further comprising an AD converter which converts an analog signal input via the vertical signal line into a digital signal, and
in which the pixel region further comprises a plurality of load transistors each having a current path having one end connected to the vertical signal line and the AD converter, and
wherein the load transistor of the source follower circuit of the unit pixel performs the operation of enabling/disabling the source follower circuit.

13. The device of claim 10, wherein the read target row is selected/made unselected by using a selection transistor connected to a drain terminal of an amplification transistor of the unit pixel.

14. The device of claim 10, wherein after enabling the source follower circuit, the vertical shift register controls the pixel region to raise a voltage of the vertical signal line in order to raise the reference level of the video signal.

15. The device of claim 14, wherein in order to read out a pixel signal, the vertical shift register controls the pixel region to enable the source follower circuit of the unit pixel, and cause an AD converter to sample-and-hold the reference level of a video signal output to the vertical signal line.

16. The device of claim 15, wherein the vertical shift register controls the pixel region to read out electric charge obtained by photoelectric conversion to the detector, and cause an AD converter to sample-and-hold the reference level of a video signal output to the vertical signal line.

17. The device of claim 16, wherein the vertical shift register controls the pixel region to disable the source follower circuit of the unit pixel.

18. The device of claim 17, wherein the vertical shift register controls the pixel region to make a selected read target row unselected.

19. The device of claim 10, further comprising a load transistor whose gate controlled by three values.
